(19) United States
(12) Patent Application Publication
(10) Pub. No.: US 2012/0042084 A1
(43) Pub. Date: Feb. 16, 2012

(54) SELF-ORGANIZING IMS NETWORK AND METHOD FOR ORGANIZING AND MAINTAINING SESSIONS

(75) Inventors: Ashutosh Dutta, Bridgewater, NJ (US); Christian Makaya, New Brunswick, NJ (US); Dana Chee, Maplewood, NJ (US); Subir Das, Belle Mead, NJ (US); Fuchun Joseph Lin, Morris Plains, NJ (US); Satoshi Kemorita, Saitama (JP); Tsunehiko Chiba, Saitama (JP); Hidetoshi Yokota, Saitama (JP)

(73) Assignees: KDDI CORPORATION, Chiyoda-ku (JP); TELCORDIA TECHNOLOGIES, INC., Piscataway, NJ (US)

(21) Appl. No.: 13/023,893

(22) Filed: Feb. 9, 2011

Related U.S. Application Data
(60) Provisional application No. 61/303,403, filed on Feb. 11, 2010.
(60) Provisional application No. 61/307,686, filed on Feb. 24, 2010.

(51) Int. Cl. G06F 15/16

(52) U.S. Cl. 709/228

(57) ABSTRACT

A method and system for setting up and maintaining an IMS session. The method comprising transmitting an invite message from a registered user equipment, forwarding the invite message to a selected SIP proxy (P-CSCF), forwarding the invite message to a specified SIP server (S-CSCF) and relaying said invite message to a destination. The invite message contains a header and a payload. The header includes an identifier for the load balancing node. The load balancing node is assigned to the user equipment. There are at least two load balancing node, a primary and a secondary load balancing node. The identifier for the load balancing node does not change even if there is a failure of one of a primary load balancing node, the P-CSCFs or S-CSCFs. During registration, the routing information for the load balancing node is added into both via and record-route headers in a SIP registration request.

### CROSS-REFERENCE TO RELATED APPLICATIONS

This application is related to and claims the benefit of and priority to U.S. provisional application Ser. No. 61/303,403 filed on Feb. 11, 2010 the entirety of which is incorporated by reference. This application is also related to and claims the benefit of and priority to U.S. provisional application Ser. No. 61/307,686 file Feb. 24, 2010 the entirety of which is incorporated by reference.

### FIELD OF THE INVENTION

This invention relates to a system and method for organizing and maintaining an IMS network.

### BACKGROUND

Multimedia services using portable devices have become prevalent in our daily life. These services can be delivery to a user equipment (UE) using an IP Multimedia Subsystem (IMS) as the architectural framework. The IMS uses Session Initiation Protocol (SIP) for establishing a session and maintaining persistency of the session. In IMS, the CSCF (Call Session Control Function) is responsible for the SIP session setup of an IMS device (i.e., User Equipment or UE) The CSCF is further divided in three components: Proxy CSCF (P-CSCF), Serving CSCF (S-CSCF), and Interrogating CSCF (I-CSCF). However, session persistency is dependent upon the proper functioning of all of these components. If one of the components fails, the session can be terminated. The SIP protocol is described in RFC 3261, the entirety of which is incorporated by reference.

### SUMMARY OF THE INVENTION

Accordingly, disclosed is a system and method for setting up and maintaining an IMS session.

The method for setting up and maintaining an IMS session comprises the steps of transmitting an invite message from a registered user equipment, forwarding the invite message to a selected SIP proxy (P-CSCF) via the load balancing node, forwarding the invite message to a specified SIP server (S-CSCF); and relaying the invite message to a destination. The invite message contains a header and a payload. The header includes an identifier for a load balancing node. The load balancing node is assigned to a user equipment. The load balancing node modifies the header before forwarding.

The forwarding of the invite message to a selected P-CSCF comprises removing the identifier for the load balancing node from the header, adding the identifier for the load balancing node into both via and record-route headers, and determining which P-CSCF of a plurality of P-CSCF is the selected P-CSCF.

The forwarding the invite message to a specified S-CSCF comprises determining which S-CSCF of a plurality of S-CSCF is the specified S-CSCF and adding routing information into the header of the specified S-CSCF by the load balancing node.

The relaying the invite message to a destination comprises adding the identifier for the load balancing node into both via and the record-route headers and relaying said invite message through said load balancing node.

In order to support scalability and high availability the SIP routing path includes at least two load balancing nodes, a primary load balancing node and a secondary load balancing node. The secondary load balancing node is for redundancy. The primary and secondary load balancing nodes are synchronized.

The method further comprises the step of transmitting periodically, from each of the at least two load balancing nodes a status message containing the identifier for each of the load balancing nodes.

The method further comprises the step of setting one of said two load balancing nodes as the primary load balancing node and setting the other of the at least two load balancing nodes as the secondary load balancing nodes.

The method further comprises the step of sharing ongoing IMS session information between said primary and secondary load balancing nodes. If the secondary load balancing node(s) do not receive the periodic transmission from the primary balancing node within a randomly determined period of time, one of the secondary load balancing nodes becomes the primary load balancing node. However, the identifier of the load balancing node does not change.

If one of the secondary load balancing nodes becomes the primary load balancing node, the method further comprises the step of advertising a new status as the primary load balancing node. If one of the secondary load balancing nodes becomes the primary load balancing node, the method further comprises the step of notifying each of a plurality of P-CSCF that the original load balancing node is down. If one of the secondary load balancing nodes becomes the primary load balancing node, it uses the shared ongoing IMS session information from the primary load balancing node to continue the IMS.

The method further comprises the step of registering a user equipment. The registering the user equipment comprises transmitting a SIP registration request from the user equipment, the SIP registration request including an identifier for the user equipment, selecting a P-CSCF based upon a selection criterion from a list of a plurality of P-CSCF, adding the identifier for the load balancing node into both via and record-route headers and relaying the SIP registration request to the selected P-CSCF.

The selection criterion can be the identifier for the user equipment.

The method further comprises the steps of transmitting a SEP ping from the load balancing node to periodically monitor each of the plurality of P-CSCF in the list of a plurality of P-CSCF and detecting if a P-CSCF is down based upon a received response to the SIP ping. If the load balancing node does not receive a response to the SIP ping from the selected P-CSCF, the load balancing node selects a new P-CSCF.

The identifier for the load balancing node does not change even if there is a failure of one of a primary load balancing node, the P-CSCFs or S-CSCFs.

The method further comprises the steps of maintaining a mapping between the registered user equipment and the selected P-CSCF and modifying the mapping between the registered user equipment and the selected P-CSCF if the selected P-CSCF is replaced by a new P-CSCF. The load balancing node does not change.

The header includes a SIP layer header and an IP layer header. The step for forwarding said invite message to a selected SIP proxy (P-CSCF) alternatively comprises the sub-steps of inspecting the IP layer header for a source of the invite message, determining the selected P-CSCF based upon the source, adding routing information for the load balancing node as a source of the invite message and adding routing information for the selected P-CSCF as a destination in said outer header. The step of forwarding the invite message to a specified SIP server (S-CSCF) alternatively comprises the sub-step of adding the identifier for said load balancing node into both via and record-route headers in the SIP layer header by the P-CSCF.

The IP layer header can have an outer header and an inner header. The step of forwarding said invite message to a selected SIP proxy (P-CSCF) alternatively comprises the sub-steps of inspecting the outer header for a source of the invite message, determining the selected P-CSCF based upon the source, adding routing information for the load balancing node as the source of said invite message in the outer header, adding routing information for the selected P-CSCF as a destination in the outer header and forwarding the invite message via a IPsec tunnel

### BRIEF DESCRIPTION OF THE FIGURES

These and other features, benefits, and advantages of the present invention will become apparent by reference to the following figures, with like reference numbers referring to like structures across the views, wherein:

FIG. 1 illustrates an exemplary system for setting up and maintaining IMS session in accordance with the invention;

FIGS. 2 and 3 illustrate exemplary flow charts for registering a UE for an IMS session in accordance with the invention;

FIG. 4 illustrates an exemplary functional diagram and message flows between elements of the system during registration in accordance with the invention;

FIG. 5 illustrates an exemplary flow chart for inviting another registered user to a session in accordance with the invention;

FIGS. 6 and 7 illustrate exemplary functional diagrams and message flows between elements of the system for a session invitation in accordance with the invention;

FIG. 8 illustrates an exemplary flow chart for maintaining session persistency with the P-CSCFs in accordance with the invention;

FIG. 9 illustrates an exemplary message flow and functional diagram for maintaining session persistency with a failed P-CSCF;

FIG. 10 illustrates an exemplary message flow and functional diagram for maintaining session persistency with a failed S-CSCF;

FIG. 11 illustrates an exemplary flow chart for maintaining session persistency with primary and second Toad balancing nodes;

FIG. 12 illustrates an exemplary message flow and functional diagram for maintaining session persistency with a failed LB;

FIGS. 13 and 14 are a second exemplary message flow between elements of the system for a session invitation in accordance with the invention;

FIG. 15 illustrates another exemplary system for setting up and maintaining IMS session in accordance with the invention;

FIGS. 16, 17A and 17B illustrate exemplary functional diagrams and message flows between elements of the system of FIG. 15 for registering a UE for an IMS session;

FIGS. 18 and 19 illustrate an exemplary functional diagram and message flow between elements of the system of FIG. 15 for a session invitation in accordance with the invention; and

FIG. 20 illustrates an exemplary SEP layer header and an IP layer header for a message sent by a UE in the system of FIG. 15 in accordance with the invention.

### DETAILED DESCRIPTION OF THE INVENTION

### Definitions

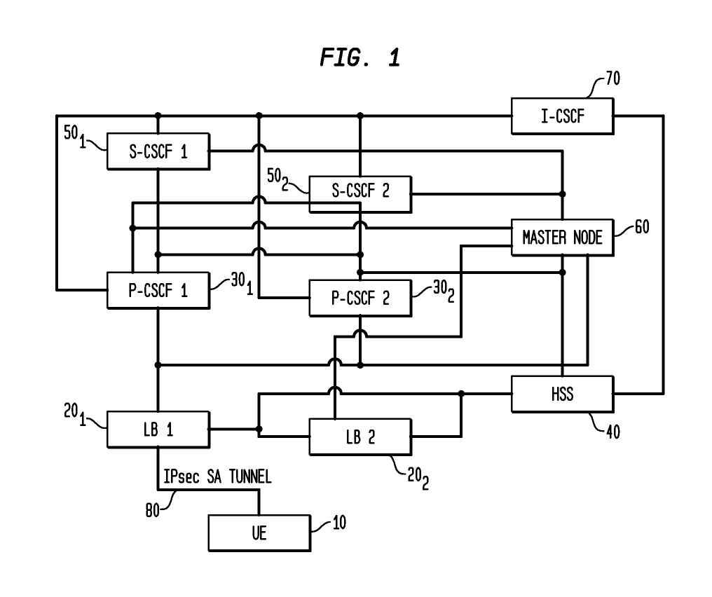

CSCF (Call Session Control Function) is responsible for the SIP session setup of an IMS device (i.e., User Equipment or UE). The CSCF is further divided in three components: Proxy CSCF (P-CSCF) 30, Serving CSCF (S-CSCF) 50, and Interrogating CSCF (I-CSCF) 70. Reference Numbers from FIG. 1.

A P-CSCF 30 is a SIP proxy that is the first point of contact for the UEs 10 within IMS. All SIP signaling traffic from the UE 10 will be sent to the P-CSCF 30. Similarly, all terminating SIP signaling from the network is sent from the P-CSCF 30 to the UE 10. The P-CSCF 30 is assigned to a UE 10 during registration. The P-CSCF 30 sits on the path of all signaling messages and can inspect every message. Moreover, it authenticates the user and establishes an IPsec security association (SA) 80 with the UE 10. The IPsec SA (hereinafter either “IPsec SA” or “IPsec tunnel”) 80 is negotiated during the registration between the UE 10 and P-CSCF 30.

IPsec is an internet security protocol that allows encryption and authentication of packets.

S-CSCF 50 is the central point of the signaling plane of IMS as it is responsible for handling registration, making routing decisions and maintaining session states, and storing the service profile(s). It is a SIP server and always located in the home network. The S-CSCF 50 uses Diameter over Cx interface to the HSS 40 to download and upload user profiles—it has no local storage of the user. It handles SIP registrations, which allows it to bind the user location (e.g., the IP address of the terminal) and the SIP address. S-CSCF 50 sits on the path of all signaling messages, and can inspect every message.

The Home Subscriber Server (“HSS”) 40 is the master user database for the IMS. It contains the subscription-related information (user profile, filtering criteria etc.), performs authentication and authorization of the user. It stores and provides information about the physical location of user. It supports all the IMS network entities that are actually handling the calls/sessions. It assigns a S-CSCF 50 to a user.

A Header is a component of a SIP message that conveys information about the message. It is structured as a sequence of header fields.

A header field can appear as one or more header field rows. Header field rows consist of a header field name and zero or more header field value.

A Dialog is a peer-to-peer SIP relationship between two user agents (UAs) that persists for some time. A dialog is established by SIP messages, such as a 2xx response to an INVITE request. It is identified by a call identifier, local tag, and a remote tag.

UA is a logical entity that can act as both a UA client (UAC) and UA server (UAS).

The UAC creates a request and sends it by using the client transaction state machine while a UAS generates a response to a SIP request.

The Call ID header acts as a unique identifier to group together a series of messages. It must be the same for all requests and responses sent by either UA in a dialog and should be the same in each registration from a UA.

SIP routing is based on five headers: Via, Route, Record-Route, Service-Route, and Path.

The Via header indicates the transport used for the transaction and identifies the location where the response is to be sent. In fact, it indicates the path taken by the request so far and indicates the path that should be followed in routing responses. The Via header field value contains the transport protocol used to send the message, the client's hostname or network address, and possibly the port number at which it wishes to receive response. Any SEP entity must insert a Via header field (with its address) into a SIP message before the existing Via header field values during the routing of the request.

The Record-Route header is inserted by proxies in a request to force future requests in the dialog to be routed through the proxy. In fact, if the proxy wishes to remain on the path of future requests in a dialog created by this request, it must insert a Record-Route header into the message before any existing Record-Route header field values, even if a Route header field is already present.

The Route header is used to force routing for a request through the listed set of proxies. For initial request originating from UE 10: its puts the P-CSCF 30(outbound proxy) address and entries of the Service-Route header. Initial request by CSCFs: setup by CSCFs find the next hop from the public user identity in the request URI (by querying DNS and HSS) or the received Path header. Subsequent requests: setup by the request-originating UE, which puts entries to the Route header as collected in the Record-Route header during initial request routing.

The Service-Route header indicates the Route header entries for initial requests from the UE 10 to the user's S-CSCF 50 (originating case). It is setup by the S-CSCF 50 which sends this header back to the UE 10 in the 200 OK response for the SIP REGISTER message. This will avoid I-CSCF as an extra hop for every initial message sent from the UE 10. Hence, the UE 10 will store the entries in the Service-Route header. Whenever the UE 10 sends out any initial request other than a SIP REGISTER message, it will: (1) include the address that were received in the Service-Route header within a Route header of a initial request, and (2) include the P-CSCF 30 address as the topmost Route entry in the initial request.

The Path header collects the Route header entries for initial requests from the S-CSCF 50 to the user's P-CSCF 30 (terminating case). It is setup by the P-CSCF 30 which adds itself to the Path header in the SIP REGISTER message and sends it to the S-CSCF 50.

FIG. 1 illustrates an exemplary system for setting up and maintaining IMS session (the “system” 1) in accordance with the invention.

The system includes at least two load balancing node (“LB”) (collectively “20”), a plurality of P-CSCF (collectively “ 30”), a plurality of S-CSCF (collectively “50”), a HSS 40, I-CSCF 70 and a master node 60. FIG. 1 illustrates two LBs 20₁ and 20₂, P-CSCFs 30₁ and 30₂, respectively and S-CSCFs 50₁ and 50₂, respectively, however, any number of LBs 20, P-CSCFs 30 and S-CSCFs 50 can be used. The P-CSCFs 30, HSS 40, S-CSCF 50, I-CSCF 70 work in a similar manner as defined above. The master node 60 assigns the functionality to each of the P-CSCFs 30, the S-CSCF 50 and the I-CSCF 70. The HSS 40 can be co-located in the same node as the master node 60.

The LB 20 acts as a front-end node and intercepts signaling traffic destined to the system 1 and redirects that traffic to the appropriate P-CSCF 30. The UE 10 accesses the system through the LB 20 using the IP address of the LB. The IP address for the LB appears as a Virtual IP address for the real services of servers/proxies and the clients or users interact with the system 1 as if there were a single proxy/server without knowing all real proxies/servers.

UE 10 sends all SIP packets/messages (hereinafter “SIP messages” or “SIP packets”) to LB 20 as a destination. Then, the LB 20 redirects/forwards these messages to an appropriate P-CSCF 30 based on its scheduling algorithms that can be influenced by master node 50, HSS 40, load of P-CSCFs 30 and so on.

LB 20 intercepts the SIP packets and modifies the appropriate headers accordingly. In the above exemplary system 1, LB 20 is SIP-aware so that it can process SIP messages received from/to UE 10 and real P-CSCF, e.g., P-CSCF 1 30₁. Having SIP-aware LB will avoid inconsistent IP address to be set in SIP messages. The Via, Record-Route and Route in SIP header will be modified for ingress and egress messages to the LB 20. In another example, the LB 20 is not SIP-aware and only modifies the IP layer header as will be discussed later.

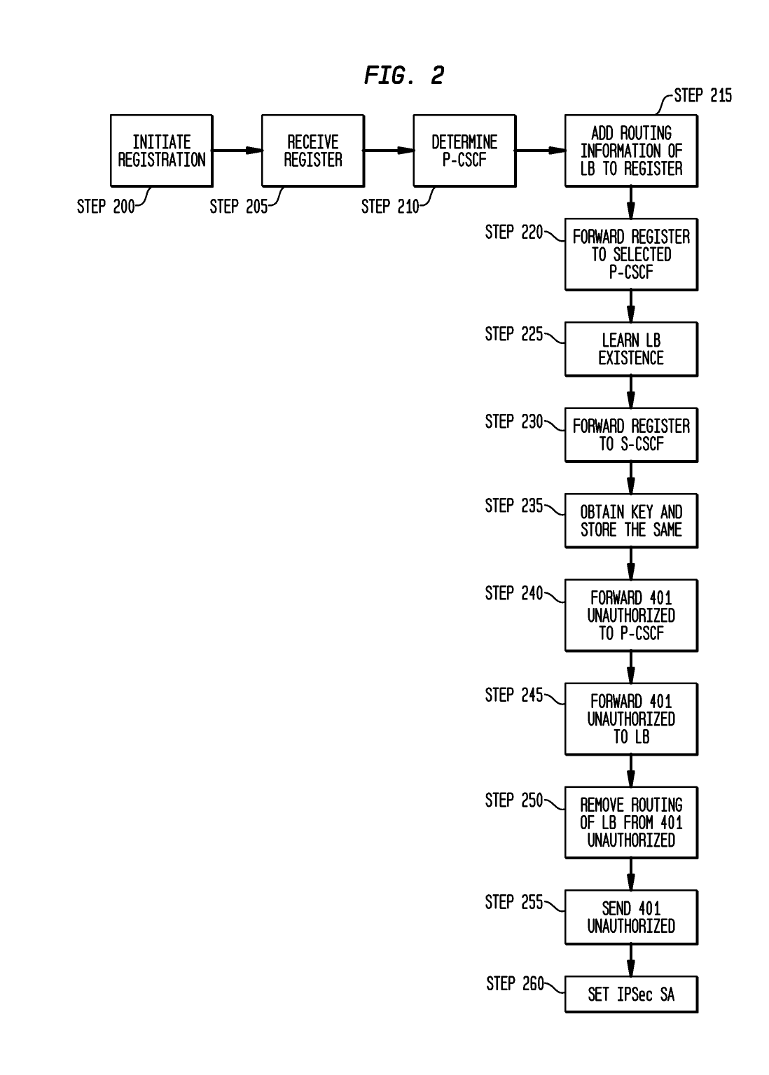

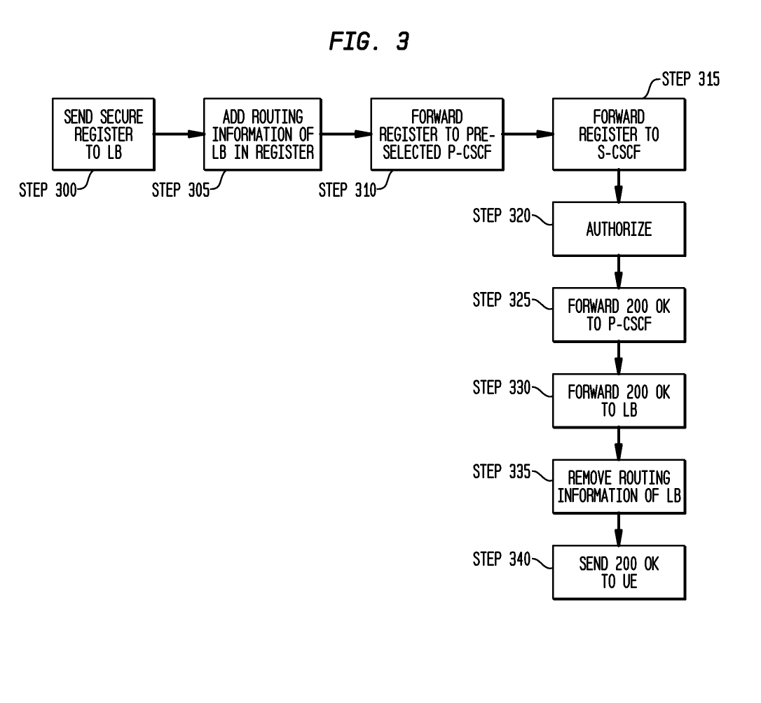

FIGS. 2 and 3 illustrate flow charts of a registration procedure for registering a UE in accordance with the invention. FIG. 2 illustrates the first part and FIG. 3 illustrates the second part.

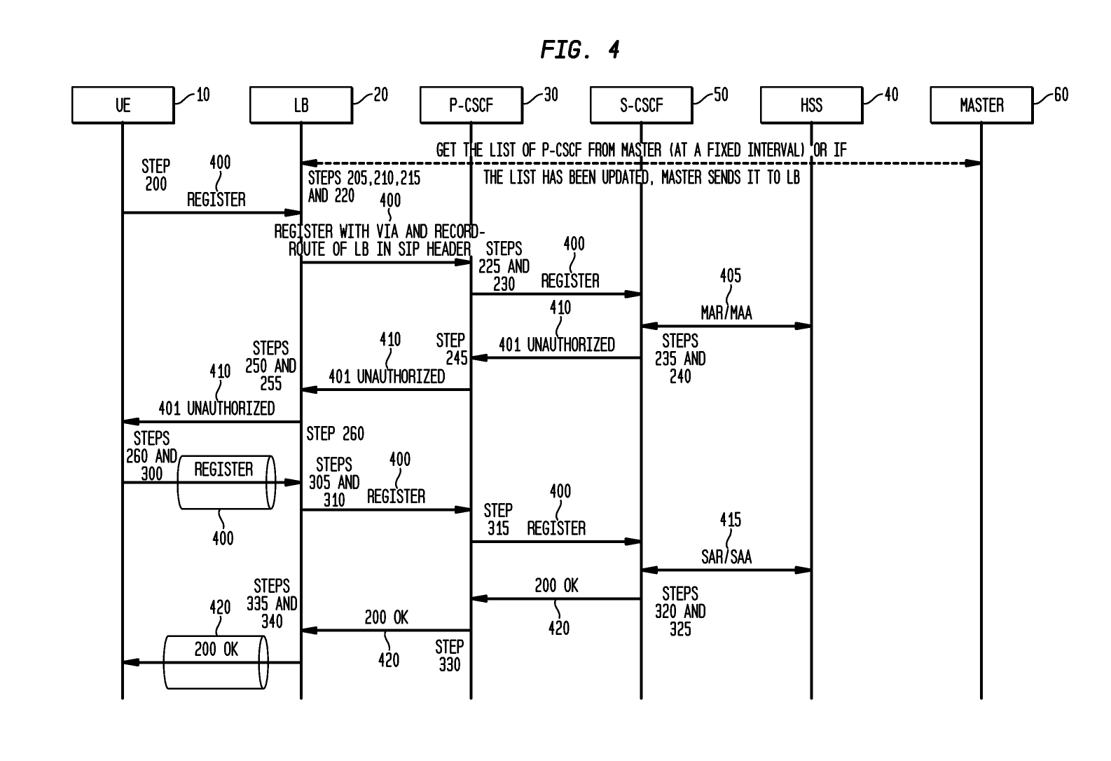

When UE 10 initiates registration procedure, it sends a SIP REGISTER (400 in FIG. 4 hereinafter “SIP REGISTER” or “REGISTER”) to LB 20, at step 200. The routing information for the LB 20 is a priori known. The master node 60 assigns a LB 20 for the UE 10. At step 205, the LB receives the SIP REGISTER 400. At step 210, the LB 20 selects a P-CSCF 30 from a list of available P-CSCFs. The selection of P-CSCF is based on different scheduling algorithm such as: hash over Call-ID, hash over from URI, round-robin, etc.

Since LB is acting as a virtual outbound SIP proxy, it processes this message and adds itself in (the topmost) the Via, Record-Route and Path headers of SIP REGISTER 400 before to forward the message to the selected P-CSCF, e.g., P-CSCF 1 30₁, at step 215. By adding its information to the Record-Route header, the LB 20 will receive the response to the request. In fact, since the LB 20 must remain on the path of future requests in a dialog created by this request, it must insert a Record-Route header into the message, even if a Route header field is already present. The LB also determines the appropriate S-CSCF e.g., S-CSCF 1 50₁. The information is conveyed to the HSS 40.

After the header is modified, the LB 20 forwards the message to the selected P-CSCF, at step 220. The selected P-CSCF adds its routing information into the appropriate header fields and learns of the existence of the LB 20 and knows to use the LB for all future messages to the UE 10 at step 225. The routing information can be an IP address, a FQDN (Fully Qualified Domain Name), etc. When the P-CSCF 30 receives the SIP REGISTER 400, it learns the presence of LB 20 on the signaling path since LB 20 entry is specified in Record-Route header of the message. The P-CSCF 30 forwards the message 400 to the selected S-CSCF, at step 230. The S-CSCF 50 and P-CSCF 30 will store the Path header information.

The S-CSCF 50 obtains the authentication and security keys from the HSS 40 (or the master node 60) at step 235. The communication between S-CSCF 50 and HSS 40 is done through a reference point Cx and a Diameter is used as protocol. The S-CSCF takes care of user authorization; security data or information is transferred over the Cx interface. When the S-CSCF 50 needs to authenticate a user it sends a Multimedia-Authentication-Request (MAR) message to the HSS 40, which responds with the Multimedia-Authentication-Answer (MAA) message (405). This answer contains among other information Authentication Data, which includes: Authentication Scheme, Authentication Information, Authorization Information, Integrity Key (IK), and, optionally, a Confidentiality Key (CK).

The S-CSCF 50 issues an unauthorized response message “401 Unauthorized” 410 in accordance with the IMS and SIP protocol. The 401 Unauthorized 410 is forwarded to the LB 20 using the reverse path. The S-CSCF 50 forwards the 401 Unauthorized 410 to the P-CSCF 240. Upon reception of 401 Unauthorized 410, the P-CSCF 30 informs the LB 20 about security association parameters (SPI), integrity key (IK) and confidentiality key (CK) received from the S-CSCF 50 associated to the UE 10. P-CSCF 30 forwards the 401 Unauthorized 410 to the LB 20 by using Record-Route header, at step 245. Upon receipt of 401 Unauthorized 410, the LB 20 removes the Via and Record-Route headers which contains its information before to send the message to the UE 20, at step 250. The 401 Unauthorized 410 is forwarded to the UE 20, at step 255.

At step 260, the LB 20 sets an IPsec SA tunnel 80 (hereinafter “IPsec tunnel” or “IPsec SA tunnel”) between the UE 10 and the LB 20. IPsec SA procedure in LB 20 is done in a similar way as by P-CSCF as specified by IMS.

With all security credentials, the UE 10 will compute the response to the challenge and send another SIP REGISTER 400 as specified by IMS and SIP protocol, at step 300. Similarly, to initial registration message process, the LB 20 adds/removes its routing information in the Via and Record-Route headers, at step 305. The LB 20 then forwards this message to the previous selected P-CSCF based on its cache or session persistence functionality set in LB 20, at step 310.

The selected P-CSCF forwards, the SIP REGISTER 400 to the appropriate S-CSCF, at step 315. When the S-CSCF 50 receives this SIP REGISTER 400, it checks the response, at step 320. To check the response, the S-CSCF 50 obtains information from the HSS 40 via a SAR/SAA 415 messages exchange. If this response is correct, the S-CSCF downloads the user profile from the HSS 40 and accepts the registration by issuing the 200 OK response (“200 OK 420”). The 200 OK 420 is forwarded to the LB 20 using the reverse path in the same manner as described above The S-CSCF 50 forwards the 200 OK 420 to the P-CSCF at step 325. At step 330, the P-CSCF 30 forwards the 200 OK 420 to the LB 20.

If the Service-Route header has been set in the 200 OK 420 by the S-CSCF 50, it is LB 20 responsibility to change this field with its own entry or remove this field and store this information for subsequent messages, at step 335. The 200 OK 420 is sent by the LB 20 to the UE at step 340. Once the registration procedure is complete, the user is able to initiate and receive IMS services. Other details of the messages and registration are well known and will not be described herein.

FIG. 4 illustrates an exemplary functional diagram and SIP message flow between the UE 10, LB 20, P-CSCF 30, S-CSCF 50, HSS 40 and master node 60 (Master in Figure). FIG. 4 is labeled with the functional steps described above with respect to FIGS. 2 and 3 to illustrate which functional server (node) is performing the described step.

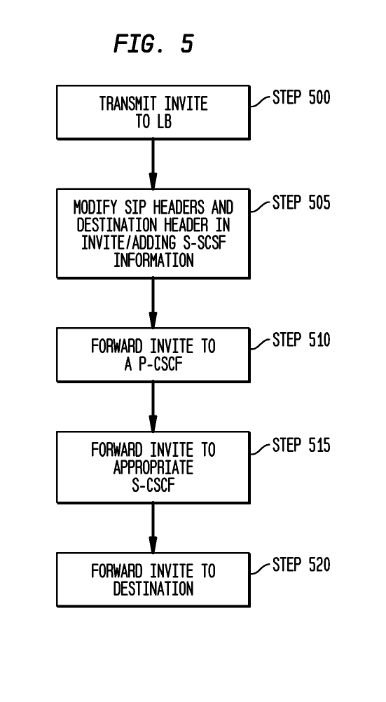

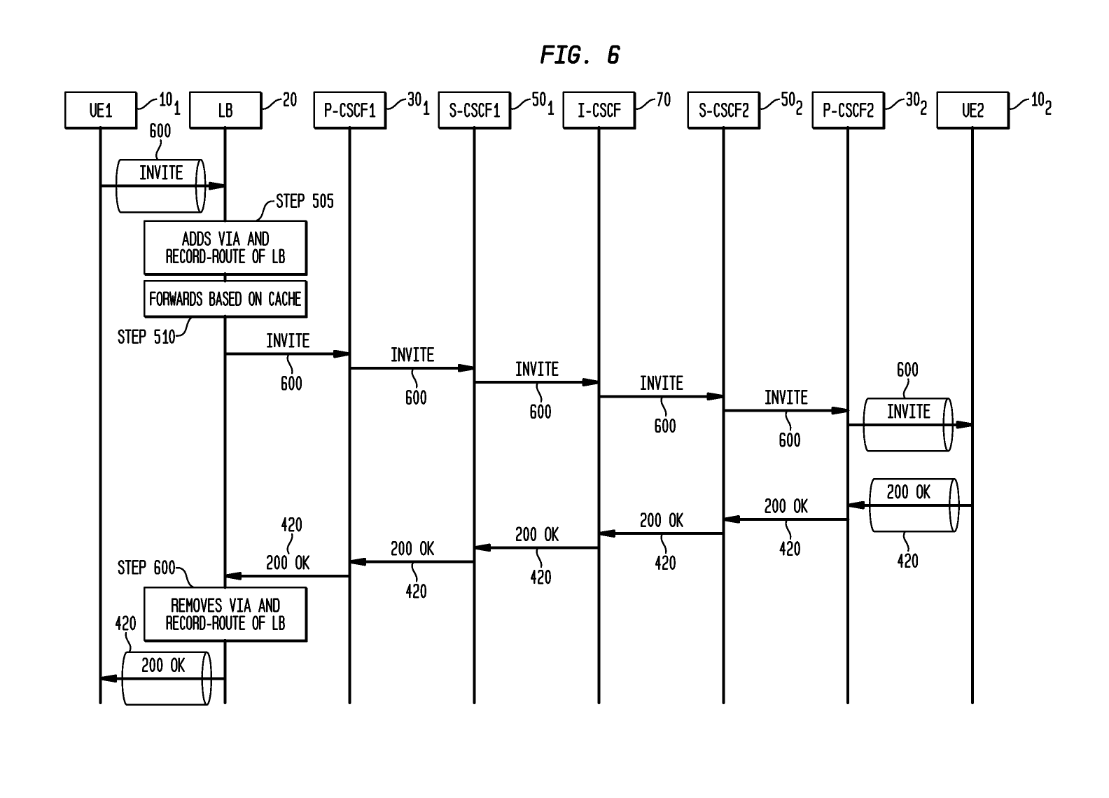

FIG. 5 illustrates a flow chart for the call setup. At step 500, the HE 10 transmits an invitation for a SIP session to another registered UE. The invite message (“INVITE 600” from. FIG. 6) is send directly to the LB 20. The UE 10 pre-loads stored information of outbound proxy (e.g., LBI 20₁) into Route header of INVITE 600 before to send it out. The LB 20 uses the same procedure as for SIP REGISTER 400 to select the P-CSCF 30, removes its own entry from Route header field, adds it own entry in Via and Record-Route headers, pre-load stored Service-Route information into Route header, adds selected P-CSCF as topmost entry of Route header, at step 505. The LB 20 then forwards the INVITE 600 to the selected P-CSCF, e.g., P-CSCF 1 30₁. By adding its own entry in the Record-Route header, this guarantees all subsequent requests within the established SIP dialog to be routed through the LB 20. LB 20 adds its own entry as required by SIP/IMS specification since it is a SIP entity (SIP proxy) at the top of the Via header, as it needs to receive all responses for the SIP INVITE (e.g., INVITE 600).

The LBs 20 also specify the S-CSCF 50, since the UE 10 does not have any information about the S-CSCF 50. In other words, it is the LB 20 responsibility to add route information through S-CSCF 50 on behalf of the UEs 10. The LB 20 either obtains the information from the HSS 40 or, if the Service-Route header was set in the 200 OK 420 during the registration, the LB 20 stores this information before forwarding the 200 OK 420 to the UE 10. LB 20 pre-loads stored Service-Route information into the Route header to allow the selected P-CSCF to route request to the right S-CSCF. The LB 20 also puts its own entry in the Path header in order to ensure that any request sent to the UE 10 first traverses the LB 20.

At step 510, the INVITE 600 is forward to the selected P-CSCF. The INVITE 600 is relayed by the P-CSCF 30 to the S-CSCF 50, at step 515. The S-CSCF 50 forwards the INVITE 600 to the destination, via multiple hops through the S-CSCF (e.g., S-CSCF 2) and P-CSCF (P-CSCF 2) that corresponds to the destination UE2 10₂.

Since both UEs 10 are registered, the route from the UE 10 its S-CSCF 50 is known. An I-CSCF 600 is used if UE 1 and UE 2 are in different domains.

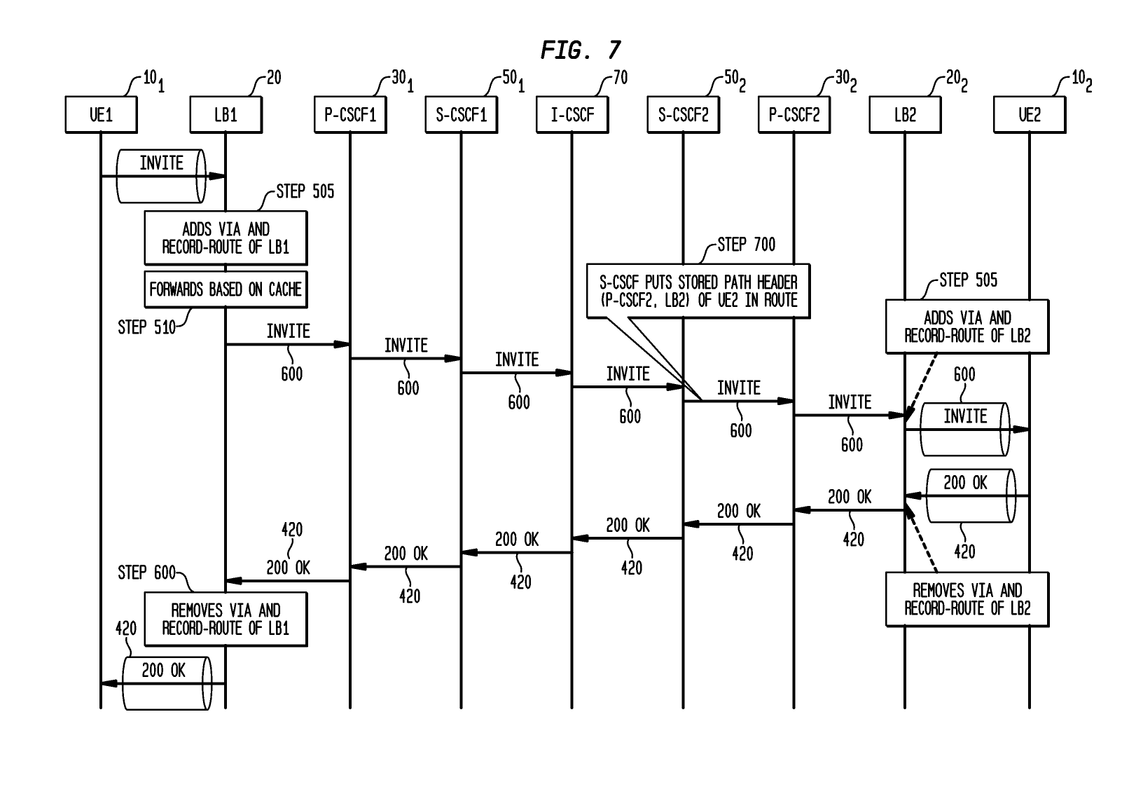

FIG. 6 illustrates the call setup procedure when the Callee (i.e., UE2) is located in IMS network domain without a LB deployed while FIG. 7 shows the call setup procedure when the Callee is located in an IMS network domain with a LB 20 (LB2) deployed. FIGS. 6 and 7 highlight certain functions of the LB 20 to support the call setting up procedure. FIG. 7 also highlights certain functions of the S-CSCF 50 to support the call setting up procedure if there is a LB used in both the caller and callee side. For example, steps 505 and 510 (from FIG. 5) are illustrated. In FIG. 6, the LB 20 adds (step 505) and removes (step 600) its routing information from the VIA and Record-Route headers upon receipt of the INVITE 600 and the 200 OK 420.

Additionally, if LBs 20 are used in both the caller and callee side, the S-CSCF 50 (e.g., S-CSCF1 50₁) on the callee side (the S-CSCF2 50₂) must put the entries of the Path header in the Route header of the SIP INVITE 600 to force the message to be forwarded through the LB2 20₂ at step 700. The routing information is established and made available during the Callee's registration. The S-CSCF (e.g., S-CSCF2 50₂) receives the Path headers from the LB2 20₂ and P-CSCF2 30₂. The LB2 20₂ adds its routing information into the Record-Route and Via of the SIP INVITE 600 for the outgoing SIP INVITE. This is done in a similar fashion as step 505 and thus step 505 is referenced in FIG. 7. This is to insure that the LB2 20₂ receives any response. In other words, by adding the routing information for the LB2 20₂, the UE2 10₂ will send back response message through LB2 20₂.

As set forth above, the S-CSCF2 50₂ adds a new-Route header, puts the LB2 20₂ address in it, and another Route header with the P-CSCF2 30₂ address, as the topmost entry, then sends this SIP INVITE 600 to the P-CSCF (i.e., P-CSCF2 30₂). The P-CSCF2 30₂ only removes its own Route header (not the entire Route headers) and adds itself to the Via header, then sends the request to the LB2 20₂. The LB2 20₂ stores the routing information and removes the whole Route, Via and Record-Route headers and adds/rewrites its own entry to the Record-Route and Via headers and then sends the request to the final destination UE2 10₂ indicated in the SIP INVITE 600. The Record-Route and Via headers of the SIP INVITE 600 are set into the response message by the Callee (i.e., UE2 10₂). The LB2 20₂ then manipulates the response by adding the stored routing information before to send out to the next hop (i.e., the selected P-CSCF2 30₂). The 200 OK 420 is sent back to UE 1 10₁ using the reverse path. When the LB2 20₂ receives the 200 OK 420, the LB2 20₂ removes its routing information from the 200 OK 420 before forwarding the message to the P-CSCF2 30₂. There is an existing IPsec tunnel 80 between the UE2 10₂ and LB2 20₂. The existing IPsec tunnel 80 is created when UE2 10₂ registers.

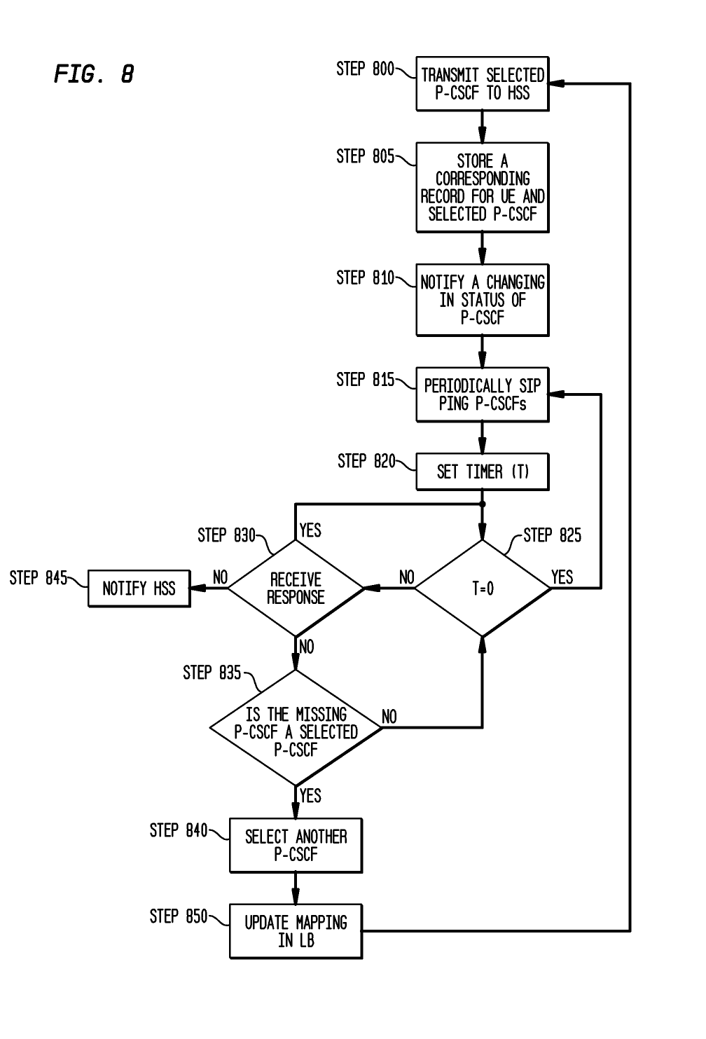

The LB 20 can also support session persistency. FIG. 8 illustrates a flow chart for an exemplary method of maintaining session persistency of a for a P-CSCF failure scenario. When the LB 20 selects a P-CSCF and associates the P-CSCF 30 with an UE 10, a notification is transmitted to the master node 60 and HSS 40, at step 800. At step 805, the HSS 40 stores an association or link between the UE 10 and the P-CSCF 30. When the link changes, the master node 60 and/or the LB 20 notifies the change, at step 810. The change will include a new association. The LB 20 periodically monitors the status of the P-CSCFs 30 and the S-CSCFs 50, at step 815. The SIP ping allows the LB 20 to monitor periodically the backend SIP servers/proxies. By using SIP ping, the LB 20 can detect when a backend SIP Proxy/Server (e.g., P-CSCF, S-CSCF) goes down, then select another backend SIP Proxy/Server to avoid session information to become inaccessible or lost of any sessions depending on these information. Once the “SIP ping” message based on SIP OPTIONS or SIP INFO method is sent, the LB 20 sets a response timer (T), at step 820. The LB then determines if the timer expired, at steps 825 and 830 with or without receiving a response of all of the P-CSCFs 30 and S-CSCFs 50. If the timer expires (“Y” at step 825), the LB 20 will send another SIP ping message.

If a response was not received from the P-CSCFs 30 and S-CSCFs 50 (“N” at step 830), then the LB 20 notifies the HSS 40 and master node 60 at step 845. Additionally, the LB 20 then determines if the missing P-CSCF or S-CSCF is active, i.e., the selected P-CSCF or S-CSCF for UE 10, at step 835. If the missing P-CSCF or S-CSCF is active (“Y” at step 835), the. LB 20 selects another P-CSCF. The selection can be based upon a caller identifier. The LB 20 then updates its internal mapping for the UE 10 (with the new P-CSCF); at step 850, however, the UE 10 uses the same LB 20 to access the system 1 or an active session. The LB 20 sends a notification to the HSS 40 and the master node 60 of the new mapping. If the timer expires (“Y” at step 825) and a response was received from all P-CSCFs 30 or S-CSCFs 50 (“Y” at step 830 and “N” at step 835), then the LB 20 will send another SIP ping message without any notification or change in mapping.

Additionally, or alternatively, the master node 60 will assist in session persistency and monitor the P-CSCFs 30 and S-CSCF 50.

When, P-CSCF1 30₁ fails, the master node 60 notifies or updates the HSS 40 about this event since the master node 60 has knowledge of alive nodes as the master node 60 assigns the IMS functionalities to nodes. The master node 60 updates list of available P-CSCFs 30 to HSS 40. When the master node detects P-CSCF1 30₁ failure, it notifies the S-CSCFs 50 about this change or event. Upon this notification, the S-CSCF 50 can retrieve information of new P-CSCF (e.g., P-CSCF2 30₂) from the HSS 40. At the same time, the S-CSCF 50 updates registration status (e.g., association and mapping) of LB 20 and UE 10 through the new P-CSCF. Then P-CSCF2 30₂ restores all registration information and updates mapping between LB 20 and UE 10 for subsequent SIP messages.

The S-CSCF 50 failover support (session persistency) is similar to P-CSCF 30 failover. When master node 60 detects the failure of S-CSCF1 50₁, it notifies all other P-CSCFs 30 about this event. Upon receipt of this notification, the P-CSCFs 30 retrieves information about a new S-CSCF 50(i.e., S-CSCF2 50₁) from the HSS 40 and updates registration information. The master node 60 assigns a new S-CSCF 50 for the session. The master node 60 sends a request to the new S-CSCF 50 to acts as the S-CSCF 50 for the session. To allow registration update, the P-CSCFs 30 is configured to store registration information. When the S-CSCF2 50₂ receives the request/notification, it restores the registration information associated to the UE 10 registered with the failed S-CSCF. The new S-CSCF2 50₂, obtains the registration information from the P-CSCFs 30.

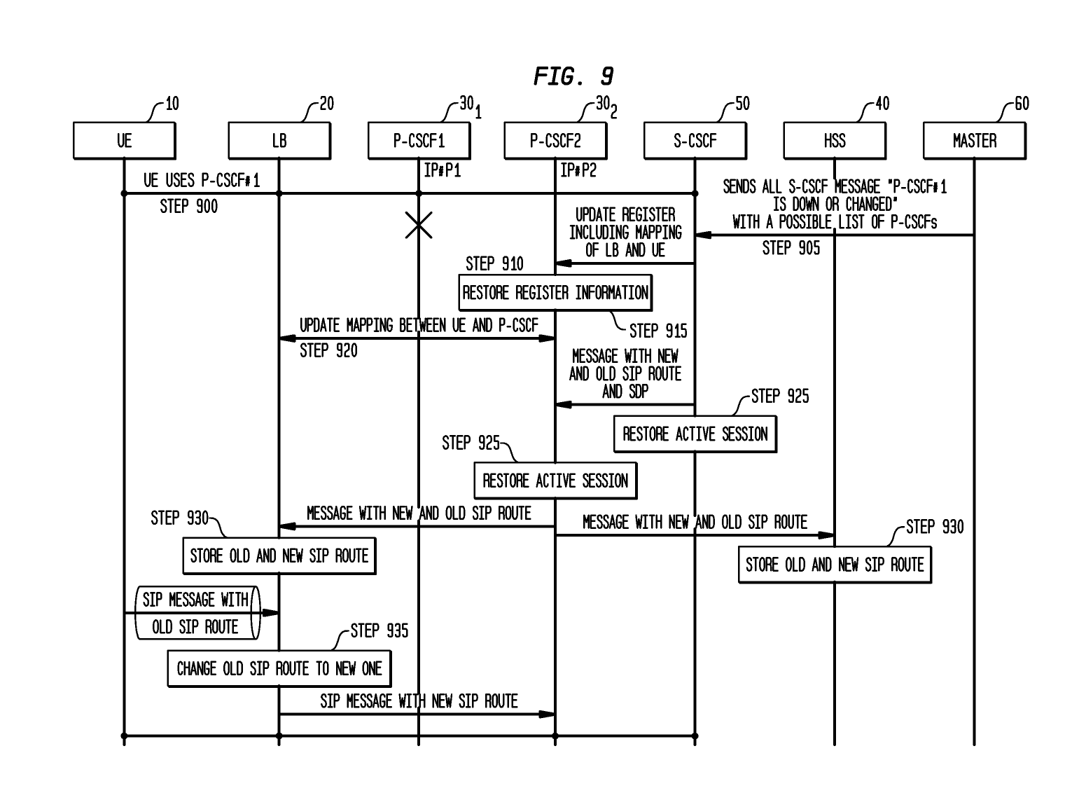

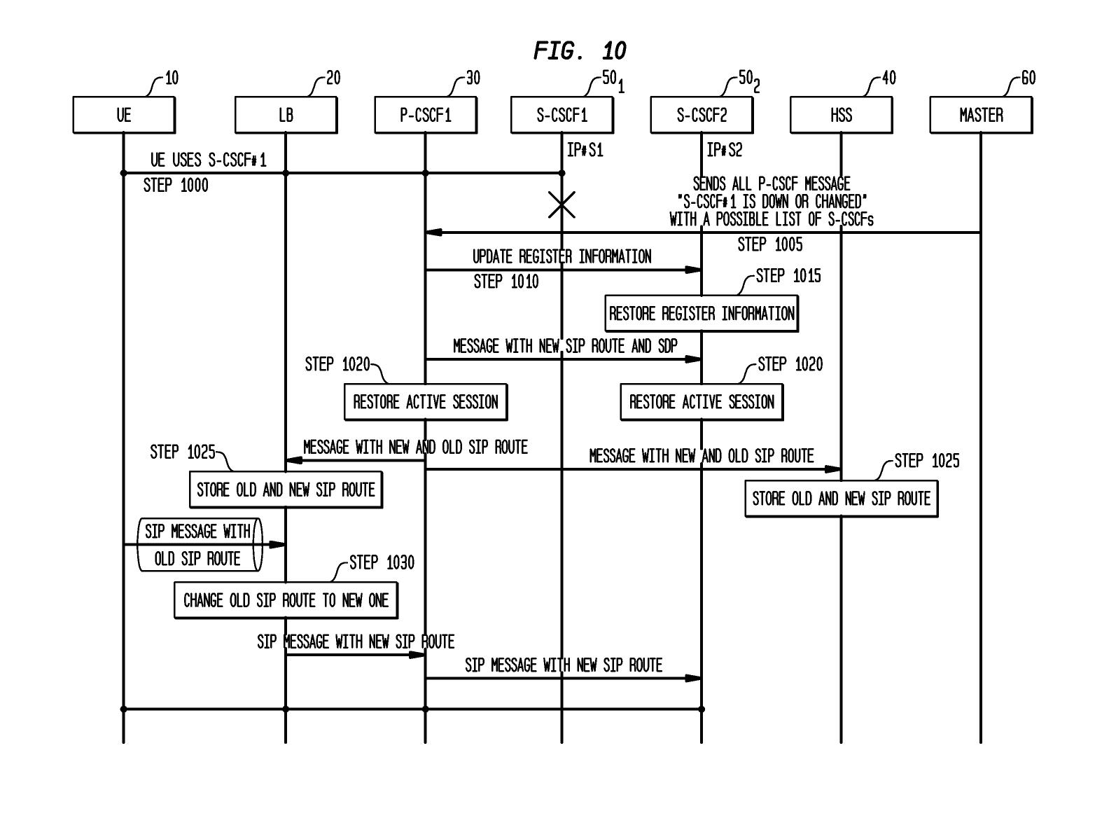

FIGS. 9 and 10 illustrate a message flow chart between the UE 10, LB 20, the P-CSCFs 30, the S-CSCF 50, HSS 40 and the master node 60 (labeled master in figure) and a high level functional chart for session persistency when a P-CSCF 30 (FIG. 9) and a S-CSCF 50 (FIG. 10) fails.

For purposes of the description there are two P-CSCFs: P-CSCF1 and P-CSCF2 (30₁ and 30₂, respectively). Each has its own IP address. IP address for P-CSCF1 is #P1 and IP address for P-CSCF2 is #P1. The UE continues to send a message on the old route no matter what happens in the backbone network, e.g., failure of a P-CSCF 30 or S-CSCF. The LB 20 performs the necessary change. At step 900, the UE 10 sends a message (dialog) using an old route and it is relayed through the LB 20, P-CSCF1 30₁ to the S-CSCF 50. At step 905, the master node 60 detects that P-CSCF1 30₁ has failed. The “X” indicates that P-CSCF1 30₁ failed. The master node 60 sends a notification to the S-CSCF 50 that P-CSCF1 30₁ has failed. The notification includes a list of alternative P-CSCFs 30. At step 910, the S-CSCF 50 sends an update Register message to the new P-CSCF2 30₂ including the mapping of the LB 20 to the UE 10 so the new P-CSCF has the updated information. At step 915, the new P-CSCF2 30₂ restores the information. The new P-CSCF obtains the entire SIP dialog that occurred on the failed P-CSCF. P-CSCF2 30₂ effectively takes over the functionality of P-CSCF1 30₁. At step 920, the LB updates the mapping for the new P-CSCF2 30₂ to the UE 10 by storing a new association for the UE 10. The S-CSCF 50 sends a message with the old and new SIP route information to the P-CSCF2 30₂ to restore the active session. At step 925 the P-CSCF2 30₂ and the S-CSCF 50 restores the active session. The S-CSCF 50 sends all subsequent messages for the ongoing session to the new P-CSCF. The SIP route header has the routing information for the new P-CSCF. The P-CSCF2 30₂ sends a message to both the LB 20 and the HSS 40 with the old and new SIP Route. At step 930, the LB 20 and the HSS 40 store the old and new SIP Route. After the new information is stored in the LB 20, all new messages received from the UE 10 will be changed by the LB 20 to the new route at step 935 and the message will be forwarded to the new P-CSCF2 30₂.

For purposes of the description there are two S-CSCFs: S-CSCF1 and S-CSCF2 (50₁ and 50₂, respectively). Each has its own IP address. IP address for S-CSCF1 is #S1 and IP address for S-CSCF2 is #S1. The UE continues to send a message on the old route no matter what happens in the backbone network, e.g., failure of a S-CSCF 50. The LB 20 performs the necessary change. At step 1000, the UE 10 sends a message (dialog) using an old route and it is relayed through the LB 20, P-CSCF 30 to the S-CSCF 50₁. At step 1005, the master node 60 detects that S-CSCF1 50₁ has failed. The “X” indicates that S-CSCF1 50₁ failed. The master node 60 sends a notification to the P-CSCF 30 that S-CSCF1 50₁ has failed. The notification includes a list of alternative S-CSCFs 50. At step 1010, the P-CSCF 30 sends an update REGISTER message to the new S-CSCF2 50₂ including the mapping of the LB 20 to the UE 10 so the new S-CSCF has the updated information. The P-CSCF 30 also sends a message with the SIP Route. At step 1015, the new S-CSCF2 50₂ restores the information in a similar manner as described above. The P-CSCF 30 sends a message with the new SIP Route information to the S-CSCF2 50₂ to restore the active session. At step 1020 the S-CSCF2 50₂ and the P-SCCF 30 restores the active session. The P-CSCF 30 sends a message to both the LB 20 and the HSS 40 with the old and new SIP Route. At step 1025, the LB 20 and the HSS 40 store the old and new SIP Route. After the new information is stored in the LB 20, all new messages received from the UE 10 will be changed by the LB 20 to the new route at step 1030 and the message will be relayed to the new S-CSCF2 50₂ via the P-CSCF 30.

As noted above, there are at least two LB 20 in the system 1. Each LB 20 has a redundant back up LB to avoid session loss. A message is periodically sent between the LB(s) 20. One of the LBs is selected as the primary LB and the others are set as a backup LB(s). The message is used between the primary and backup LB to inform each other they still alive. The primary and backup LBs are synchronized in order to share the ongoing session information (e.g., SIP dialog).

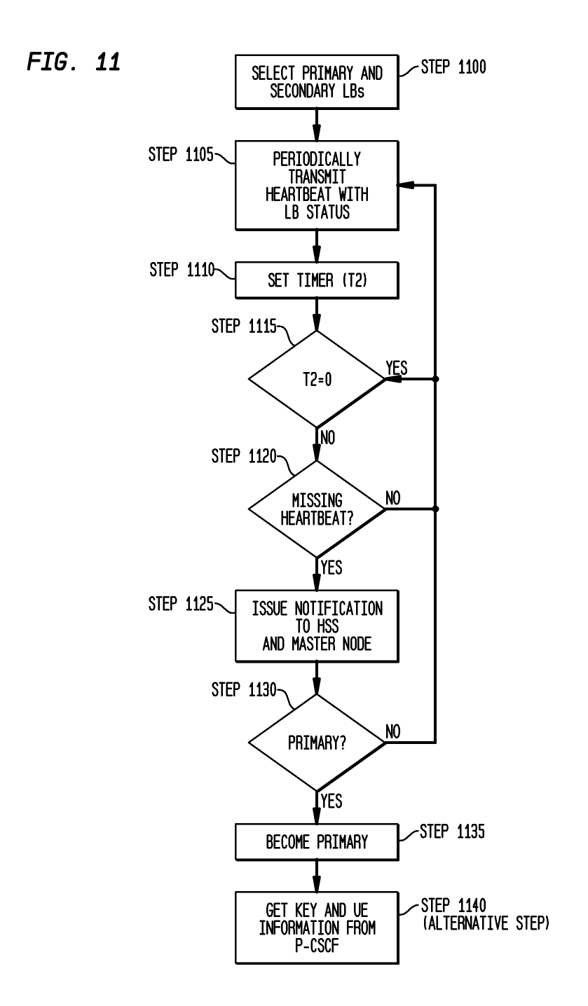

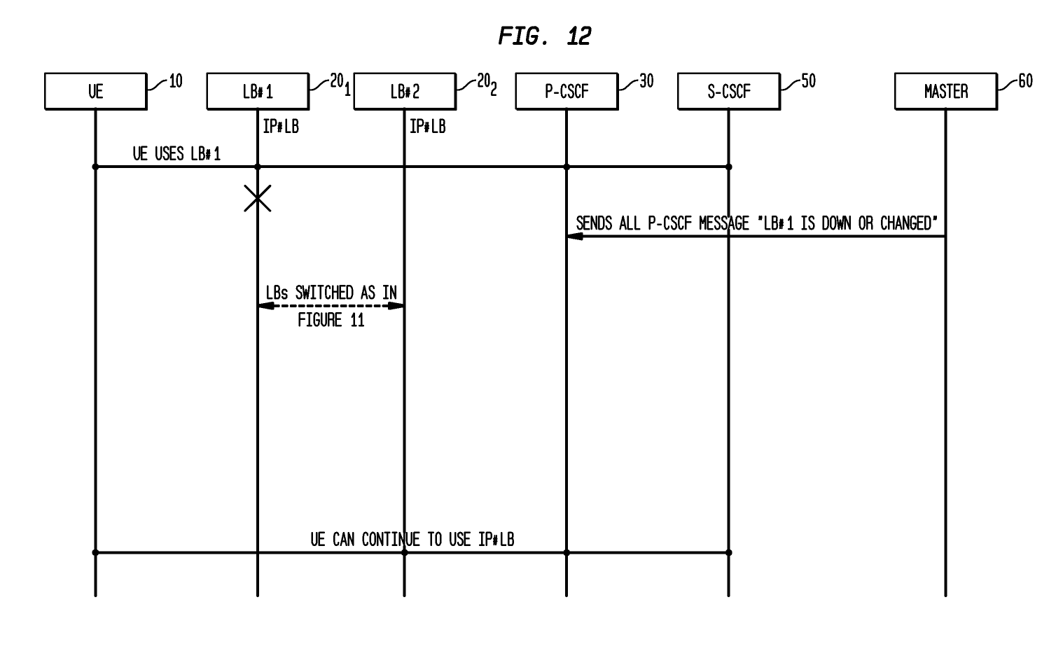

FIG. 11 illustrates a flow chart for LB using redundancy. At step 1100, a primary LB and at least one secondary LB is selected and set. Each LB periodically transmits a heartbeat message with its LB status. The period can be randomly determined. Alternatively, the period for the primary LB can be set to be shorter than the period for the secondary LBs. At step 1110, each LB 20 sets a timer (T2). When the timer expires (“Y” at step 1115), the LB 20 sends the heartbeat message. At step 1115, each LB 20 determines if the timer expired. At step 1120, each LB 20 determines if a heartbeat was not received from one of the LBs 20. If a heartbeat was not received from one of the LBs (“Y” at step 1120), the LB 20 informs the HSS 40 and master node 60, at step 1125. The LB 20 will transmit a message with the identifier of the LB 20 and indicate that the LB has failed. Additionally, the LB 20 will determine if the missing heartbeat belonged to a primary LB, at step 1130. If the primary LB 20 has failed (“Y” at step 1130). The LB 20 takes over as the primary LB, at step 1135. Since the LBs are synchronized, the transition to the primary LB 20 is streamlined Alternatively, the new LB will obtain security keys and UE information from the active P-CSCF (or HSS) at step 1140. All future messages associated to the dialog for the session will be routed through the new LB 1140.

The new primary LB will take over the Virtual IP address (VIP) in order to provide the load balancing service to the whole session and system 1. The backup LB takes over the load balancing service with previous session information or state available in the primary LB. This will guarantee that ongoing sessions will continue or remain active through the new primary LB.

FIG. 12 shows the message call flows for LB failover support and session persistency. Once the failure of the primary LB (e.g., LB#1 in FIG. 12) occurs and the secondary LB (e.g., LB#2 in FIG. 12) takes over the service, the master node 60 notifies the P-CSCF 30 about the failure. Since information in LB#1 20₁ and LB#2 20₂ are synchronized, the IPsec SA parameters will be transferred to LB#2 20₂. Otherwise, LB#2 20₂ can retrieve these security parameters from HSS 40 or P-CSCF 30. Both LBs can use the same IP address IP=#LB.

In the above example, the LB 20 modifies the SIP header at the SIP layer of the message (packet), however, the LB 20 can alternatively modify the IP header in the IP layer (“IP layer header”) of the message (packet) before forwarding to the selected P-CSCF 30. The LB 20 forward SIP packets based on SIP inspection but it doesn't change the SIP messages. Instead of the LB 20 modifying the SIP headers, the P-CSCF 30, modifies the. SIP header. Specifically, the P-CSCF 30 adds/removes LB information (e.g., IP address and FQDN) in Via and Record-Route headers of SIP message.

When UE 10 initiates registration procedure, it sends a REGISTER 400 request to LB 20. The UE 10 sets LB information (e.g., IP address and FQDN) in the Route header of this registration message. The. LB 20 will forward this request to the selected P-CSCF 30 without adding its information in the Via and Record-Route headers. The destination address of this packet is set to the VIP of LB 20. The LB 20 will set its routing information as source address and the selected P-CSCF 30 as destination address at IP layer. When the P-CSCF 30 receives this message, it will discovery through the Route header the existence of LB 20 on the path, then it adds its own information in the Via and Record-Route headers of the SIP message before to forward this message to the next hop, e.g., S-CSCF 50. By adding its own entry in Via and Record-Route headers, this guarantees all subsequent requests within the established SIP dialog to be routed through the P-CSCF 30, and through the LB 20 since the P-CSCF 30 is aware of the LB 20 presence.

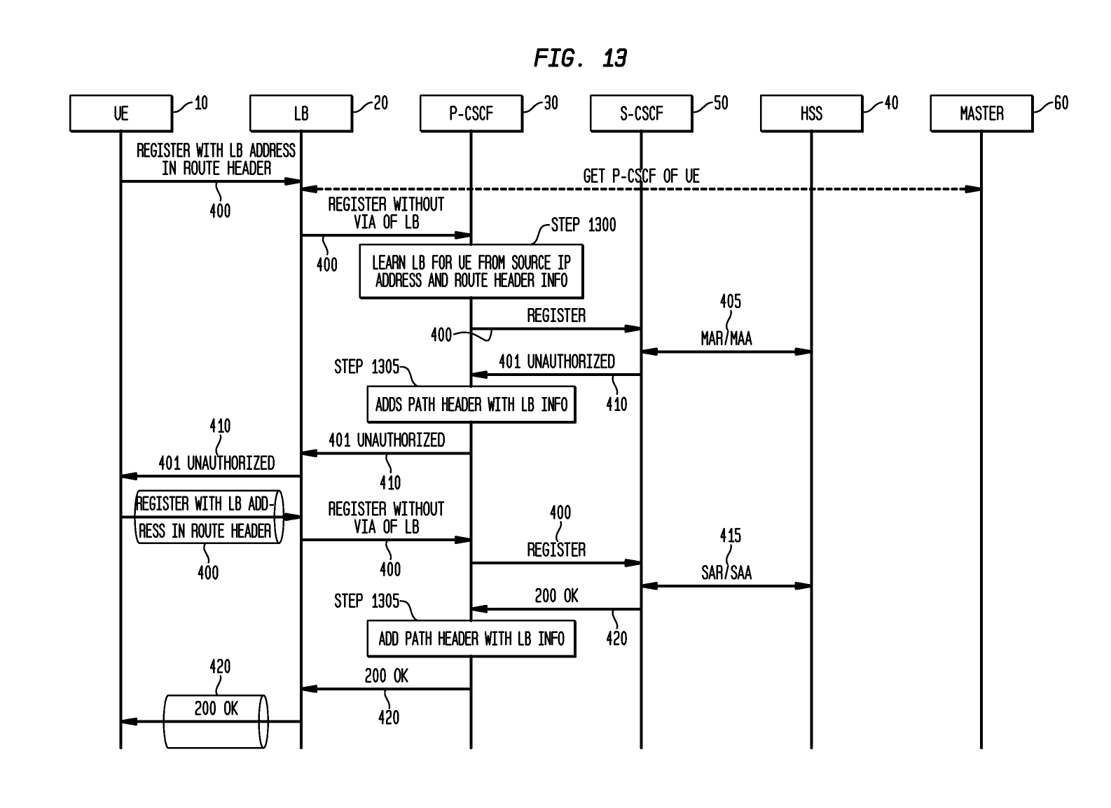

FIG. 13 illustrates an exemplary message flow and high level function diagram for the P-CSCF for the registration process where the LB 20 only modifies the IP layer header. FIG. 13 is similar to FIG. 4 except that the P-CSCF learn of the LB 20 from the source IP address in the IP layer header in the IP layer instead of the SIP layer header at step 1300 and the P-CSCF 30 adds path headers with the LB information at step 1305, instead of the LB 20. FIG. 13 uses the same reference numbers for the messages as FIG. 4. Additionally, the LB 20 forwards the message to the P-CSCF1 30₁ without modifying any of the SIP headers in the SIP layer. The UE 20 includes the routing information of the LB 20 in the Route header in the SIP layer of the REGISTER 400. When the P-CSCF 30 receives the REGISTER it will look at the source address in the IP layer header and the Route header in the SIP layer of the REGISTER 400 to learn of the LB 20. In this example, the LB does not have to be a SIP entity.

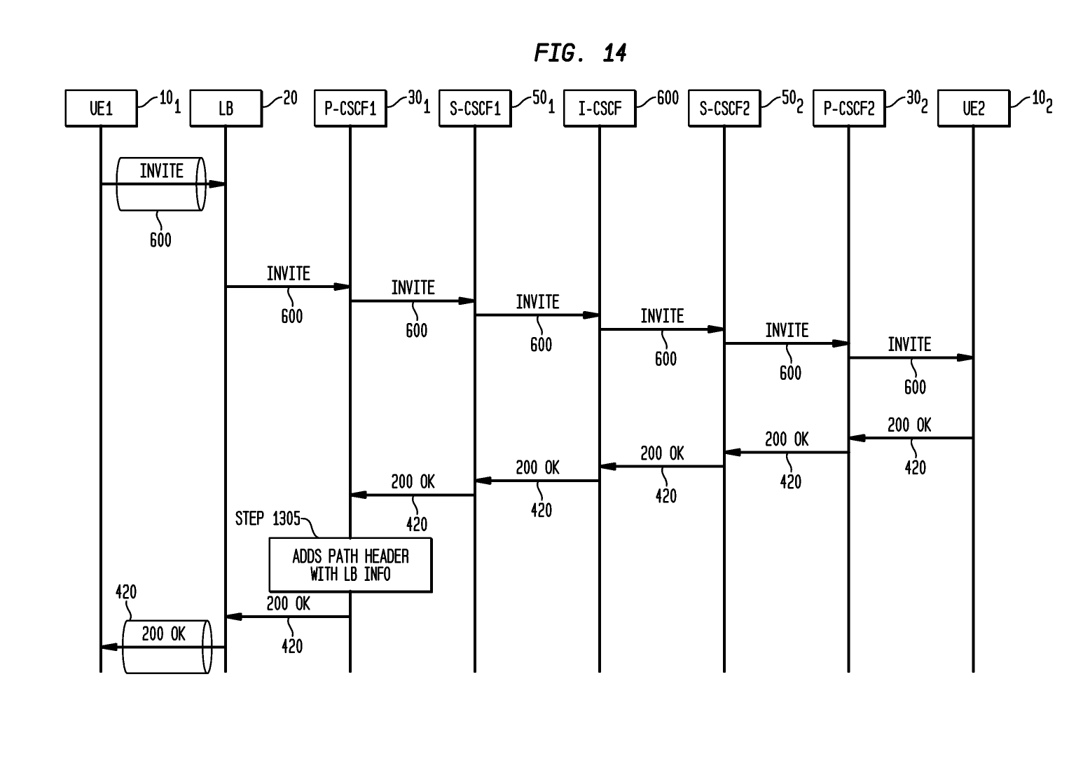

FIG. 14 illustrates an exemplary message flow and high level function diagram for the call setup process where the LB 20 only modifies the IP layer header. FIG. 14 is similar to FIG. 6 except that the P-CSCF 30 adds path headers in the SIP layer header at the SIP layer with the LB information at step 1305, instead of the LB 20. This allows the message to be routed to the LB 20 to return to the UE1 10₁ FIG. 14 uses the same reference numbers for the messages as FIG. 6. Additionally, the LB 20 forwards the message to the P-CSCF1 30₁ without modifying any of the SIP headers in the SIP layer.

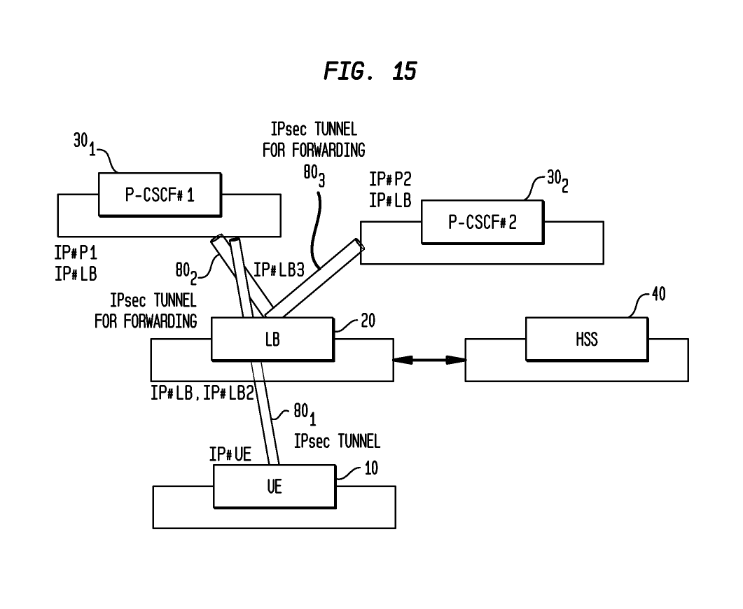

FIG. 15 illustrates another exemplary system for setting up and maintaining IMS session (the “system” 1A) in accordance with the invention. FIG. 15 only illustrates a portion of the system 1A to highlight the differences. However, system 1A has S-CSCFs 50, a master node 60, and I-CSCF 70. System 1A is substantially similar to system 1 except that an IPsec SA (IPsec tunnel 80₁) is created between the UE 10 and the P-CSCFs 30. The IPsec SA effectively creates a secured tunnel between the UE 10 and the P-CSCFs 30. Additionally, a set of IPsec SA exists between the LB 20 and each P-CSCF 30, i.e., secured tunnels between each P-CSCF 30 and the LB 20 (IPsec Tunnels 80₂ and 80₃). These tunnels are pre-established and are not created each time an IMS session is set up. The LB 20 forwards IP packets to P-CSCF 30 based on information available in HSS 40 about a mapping between UE 10 and P-CSCFs 30.

LB has three different routing addresses, e.g., IP addresses, on its physical interface. Two addresses are on the “southbound side” in which one is virtual and one on the “northbound side”, e.g., IP#LB (virtual) and IP#LB2 (physical) on the southbound and IP#LB3 on the northbound. South and northbound are relative terms uses for simplifying the description, and are not defining actual directions. The Southbound interface is between the UE 10 and the LB 20 and the Northbound interface is between the LB 20 and the P-CSCFs 30. Additionally, each P-CSCF has two routing addresses, one being for the physical interface and the other being a virtual address that is the same for all P-CSCFs 30. The virtual address is the address of the LB 20. This address is either pre-configured or unicast by the LB 20 to UE 10 when P-CSCF address is discovered. For example, the address can be pre-configured by the system operator. Alternatively, the address can be discovered using existing protocols such as, but not limited to, Dynamic Host Configuration Protocol (DHCP).

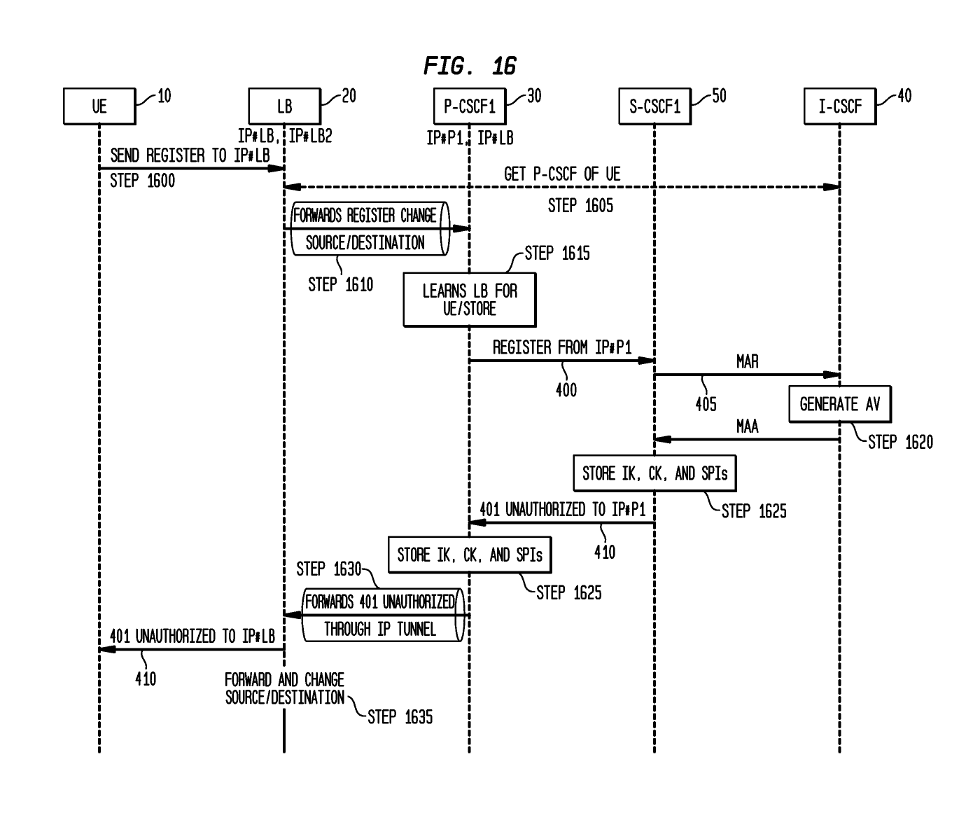

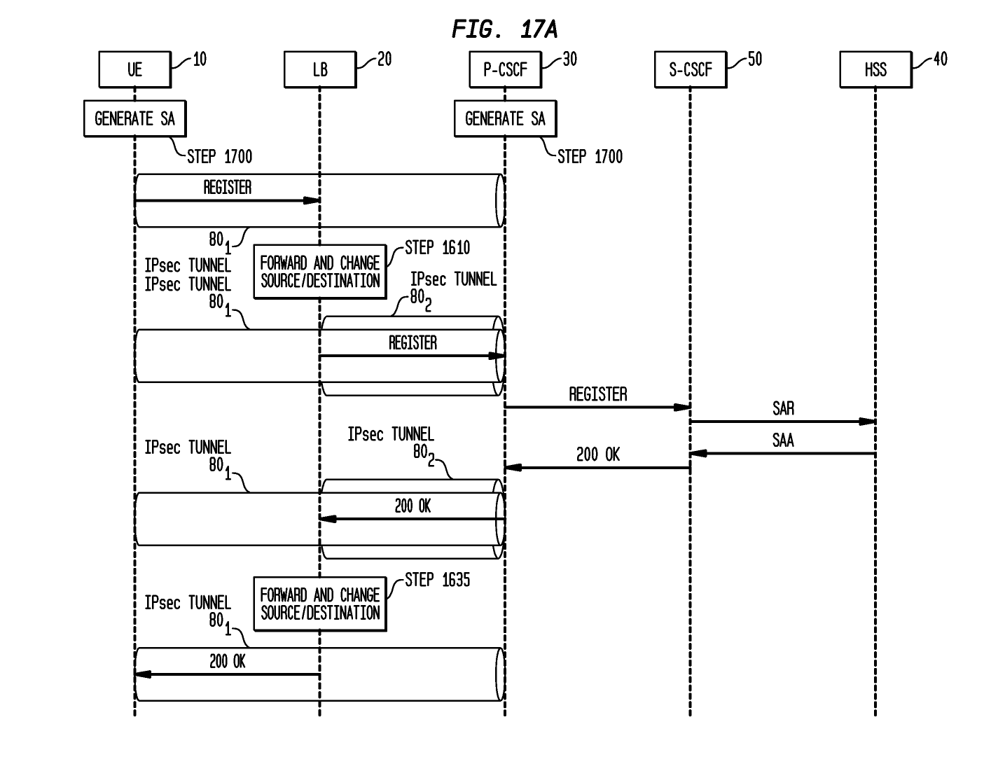

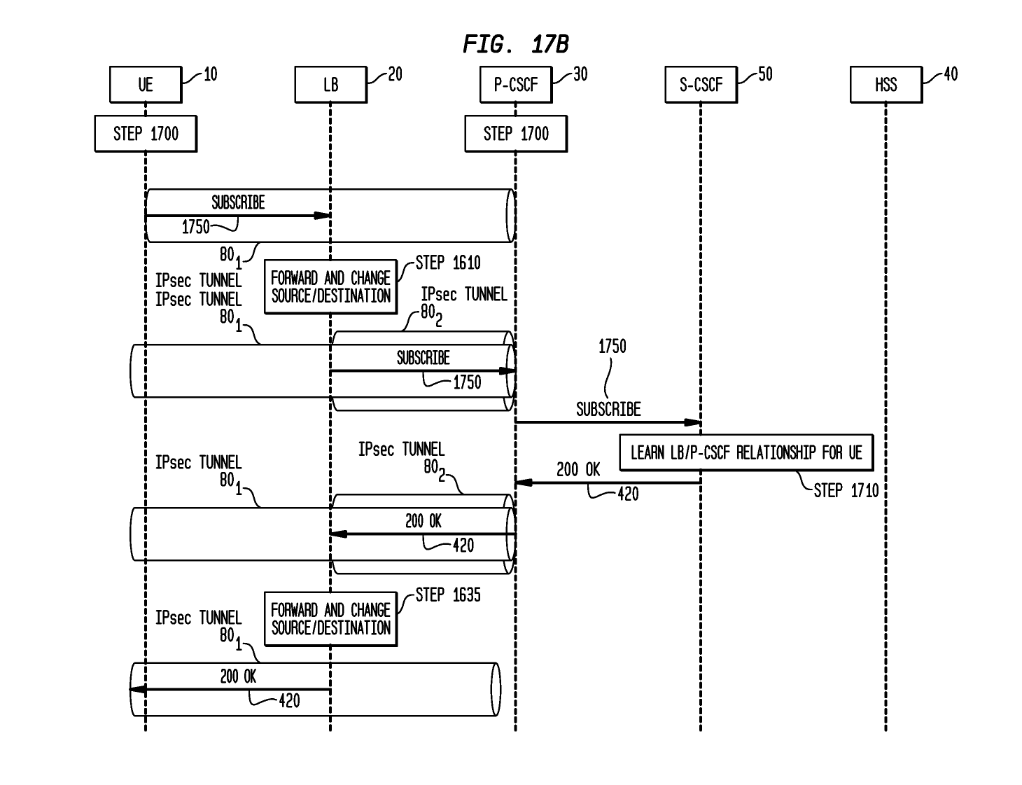

FIGS. 16, 17A and 17B illustrate an exemplary message flow and functional diagram for registering a UE for an IMS session. Certain functional steps in FIGS. 16 and 17 have been labels with reference numbers for the purpose of this description. The same functional steps use the same reference numbers across FIGS. 16, 17A and 17B. Other message flow transmission (steps) is not labeled and is transmitted in accordance with SIP protocol. When UE initiates registration procedure, it sends a SIP REGISTER 400 to LB 20 at step 1600 thinking the LB 20 is the P-CSCF 30. The SIP REGISTER 400 has a SIP layer header in which the destination address is the LB's virtual address and a source address is UE's own routing information, e.g., IP address. At an IP layer, the UE 10 uses routing information for the LB 20 physical address, e.g., LB#2, as the IP layer destination and the source address is the UE's own routing information. The LB 20 is assigned by the master node 60 for a UE 10.

After receiving the IP packet, the LB 20 inspects only the IP layer header. Based on HSS mapping information between UE 10 and the P-CSCFs 30 that is stored as a lookup table in the LB 20, the LB 20 determines which P-CSCF 30 to forward the packet at step 1605.

Table 1 is an example of the lookup table.

TABLE 1

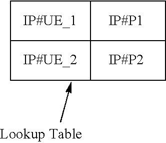

Once the LB determines the appropriate P-CSCF 30, it substitutes the routing information for the physical interface for the appropriate P-CSCF, e.g., P-CSCF#1 30₁ (IPI#=P1) for the destination and substitutes its routing information as the source (routing information for the Northbound interface, at step 1610). On the return trip, the reverse process occurs at the LB 20. At step 1610, the LB 20 forwards the REGISTER 400 to the P-CSCF 30. The P-CSCF 30 inspects the REGISTER 400 and learns of the LB 20 for the UE 10 at step 1615. The P-CSCF 30 stores the routing information for the LB 20 and associates the same with the UE 20. The REGISTER 400 is forwarded to the S-CSCF 50. The S-CSCF 50 issues a MAR to the HSS 40 (or master node 60). The HSS 40 (or master node 60) generates the authentication vector (AV) for the UE 20 at step 1620 and sends a MAA with the IK, CK and SPIs to the S-CSCF 50. The S-CSCF stores the information and associates the information with the UE 10, at step 1625. The S-CSCF 50 issues a 401 Unauthorized message 410 for the UE 10. The message is relayed through the P-CSCF 30 and LB 20. The P-CSCF receives the 401 Unauthorized 410 and stores the information and associates the information with the UE 10, at step 1625. Since this is done in the same manner as the S-CSCF the same reference number for the step is used. The P-CSCF 30 forwards the message to the LB 20 at step 1630. The LB 20 receives the 401 Unauthorized and forwards the same to the UE 10 and substitutes its routing information as source and changes the destination to the UE routing information in the IP layer header at step 1635.

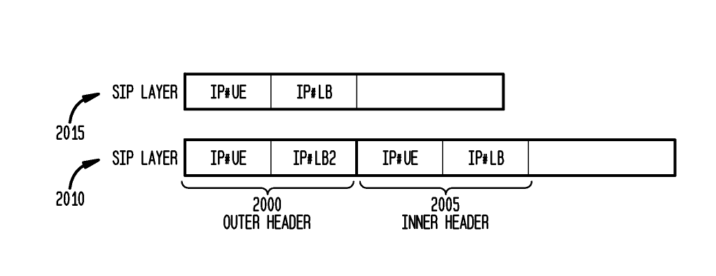

With all security credentials, the UE 10 will compute the response to the challenge and send another SIP REGISTER 400 as specified by SIP protocol. The SIP REGISTER 400 message has headers in the SIP layer 2015 and the IP layer 2010. FIG. 20 illustrates an exemplary SIP layer 2015 and IP layer header 2010 for the SIP REGISTER 400. The IP layer has an inner 2005 and outer header 2000. At the SIP layer, has a SIP layer header 2015 in which the destination address is the LB's virtual address and a source address is UE's own routing information, e.g., IP address. At the IP layer, the outer header 2000 has the physical address provided to the UE of the LB (e.g., LB#2) the outer header destination and the source address of the header is the UE's own routing information. The inner header 2005 has the destination address of the LB's virtual address and the source address is the. UE's own routing information, e.g., IP address. At step 1700, an IPSec tunnel 80 is established between the UE 10 and the P-CSCF 30. The LB 20 can only see the outer header 2000 for the IP layer header 2010 once IPsec SA 80₁ is established between the UE 10 and a P-CSCF 30, the inner header 2005 is hidden from the LB 20. At step 1610, the LB 20 inspects the outer header 2000 in the IP layer header 2010 for the source, and substitutes its own routing information in the source header (Northbound interface address). The LB 20 substitutes the destination in the REGISTER 400 with the address of the P-CSCF 30 that is in cache. The LB 20 then forwards this message to the previously selected P-CSCF. The message is forwarded via a preexisting IPsec tunnel 80₂ (which is a tunnel outside the IPsec tunnel between the UE 10 and the P-CSCF 30). The P-CSCF 30 forwards the REGISTER 400 to the S-CSCF 50. When the S-CSCF 50 receives this REGISTER 400, it checks the response. If this response is correct, the S-CSCF 50 downloads the user profile from the HSS 40 and accepts the registration by issuing the 200 OK 420. The 200 OK 420 is relayed to the UE 10 via the LB 20 and P-CSCF 30. The P-CSCF 30 forwards the 200 OK 420 to the LB 20 via the preexisting IPSec tunnel 80₂ (which is a tunnel outside the IPsec tunnel between the UE 10 and the P-CSCF). The message is effectively sent using both tunnels. When the LB 20 receives the message, it inspects the outer header 2000 in the IP layer header 2010, and substitutes its own routing information in the source header (Southbound interface address) at step 1630. The LB 20 substitutes or changes the destination from itself to the UE 10 also at step 1630. The message is forwarded to the UE 10 via the IPsec tunnel 80₁. When the UE 10 receives the 200 OK 420 it registers the physical address of the assigned P-CSCF, e.g., IP#P1 for later use (e.g., for INVITE 600 message) as the. SIP destination address for the SIP layer header 2015.

Once the registration and authentication have succeeded, the UE 10 sends out a SUBSCRIBE (“SUBSCRIBE 1750) as specified by the SIP Event Packet protocol. The format for the SUBSCRIBE 1750 is well known and governed by the SIP Event Package protocol and will not be described herein in detail. The SUBSCRIBE 1750 is sent via the IPsec tunnel 80₁. If a tunnel does not exist between the UE 10 and the P-CSCF, the tunnel is created at step 1700. If the IPsec tunnel 80₁ exists, the same tunnel will be used. The SUBSCRIBE 1750 is relayed to the S-CSCF 50 in a similar manner as described above for the REGISTER, therefore, the relay process and message flow will not be described in detail again. Once the SUBSCRIBE 1750 is received at the S-CSCF 50, the S-CSCF 50 inspects the SIP layer headers 2015 and IP layer headers 2010 and learns of the association or relationship between the LB 20 and P-CSCF 30 and the UE 10. The routing information for the LB 20 and P-CSCF 30 is stored at the S-CSCF 50. The S-CSCF 50 transmits a 200 OK 420 to the UE 10 after the information is stored. The 200 OK 420 is relayed to the UE 10 in a similar manner as described above, therefore, the relay process and message flow will not be described in detail again.

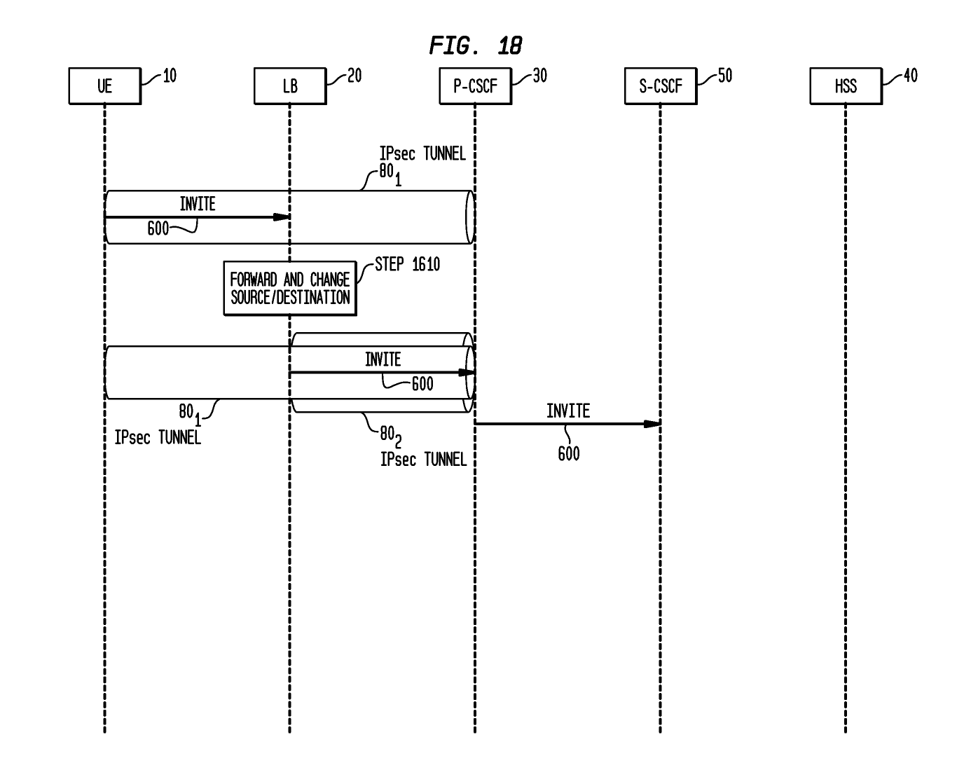

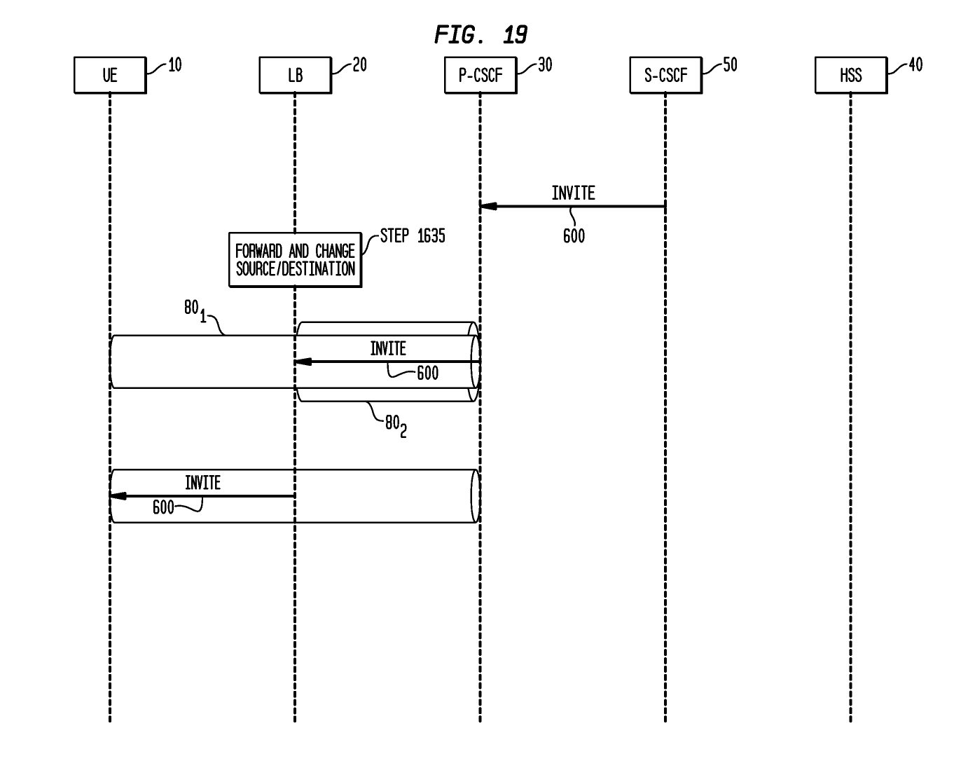

FIGS. 18 and 19 illustrate an exemplary functional diagram and message flow between elements of the system of FIG. 15 for a session invitation in accordance with the invention. FIG. 18 illustrate the message flow and functional diagram for the caller side and FIG. 19 illustrates the message flow and function diagram for the callee side. In FIGS. 18 and 19, the caller and callee are in the same home subscriber network. As depicted in FIG. 18, the UE 10 sends an INVITE 600 in the IPsec tunnel 80₁. The LB 20 receives the INVITE 600 and inspects the outer header 2000 from the IP layer header 2010. At step 1610, the LB 20 substitutes its routing information for the Northbound Interface as the source of the INVITE 600 and substitutes the actual physical interface routing information for the P-CSCF 30. The LB 20 knows which P-CSCF to forward the INVITE 600 based upon the registration. The LB 20 forwards the INVITE 600 to the P-CSCF 30 via its IPsec tunnel 80₂ with the P-CSCF. The two tunnels, acts as a tunnel within the tunnel, where the IPsec tunnel 80₂ is on the outside. The P-CSCF 30 forwards the INVITE 600 to the S-CSCF 50. On the callee side, as depicted in FIG. 19, the S-CSCF 50 forwards the INVITE 600 to P-CSCF 30. The LBs, P-CSCFs and S-CSCFs depicted in FIGS. 18 and 19 might not be the same network nodes and the references in these figures are for the functionalities of the nodes rather than identify the specific node.

The P-CSCF 30 forwards the INVITE 600 to the LB 20 via the IPsec tunnel 80₂ on the outside of the IPsec tunnel 80₁. The LB 20 receives the INVITE 600 and inspects the outer layer 2000 of the IP layer header 2000 and substitutes its routing information as the source and adds the UE routing information as the destination. The LB 20 then forwards the INVITE 600 via the IPSec tunnel 80₁.

Since there is an IPsec Tunnel 80₁ between the UE 10 and a P-CSCF 30 and another IPsec Tunnel 80₂ between the LB 20 and P-CSCF 30, if the LB 20 or a P-CSCF 30 fails, an IPsec tunnel between the LB 20 and P-CSCF 30 must be established.

Additionally, a session persistency or continuity can also be achieved by the SIP network nodes or entities in the system 1A notifying the UE 10 of a change by using SIP REFER message with a Replace Header. This is because the LB 20 is an IP layer entity and not a “SIP entity”. The LB 20 does not have any status memory or state memory of other SIP network nodes or entities such as P-CSCF 30 or S-CSCF 50. In order to maintain or restore active session, a node within the session, such as a P-CSCF 30 or S-CSCF 50 will generate a SIP REFER message with Replace Header and send it out to the new P-CSCF or S-CSCF in accordance with SIP protocol. The format of the REFER message is well known and described in the SIP protocol and therefore, will not be described herein in details.

Upon receipt of SIP REFER message, the message is forwarded to the UE 10 through the LB 20. The SIP REFER message is forwarded from the P-CSCF 30 to the UE 10 in the IPsec tunnel 80₁, as described herein. The. LB 20 will receive the SIP REFER message from the P-CSCF 30 via the outer IPsec tunnel, e.g., IPsec tunnel 80₂. The LB 20 will change the IP layer header 2010 (substitute source address with its routing information and substitute destination address with the routing information for the UE 10) in a similar manner as described above. When the UE 10 receives and processes the REFER message, it issues an initial INVITE (e.g., INVITE 600) with the Replace Header. The initial INVITE does not start a new session, but rather continues the old session. If a P-CSCF 30 fails, the S-CSCF 50 will issue a REFER having a Replace Header. The routing information for a new P-CSCF 30 will be obtained by the S-CSCF 50 from either the HSS 40 or the master node 60. The S-CSCF 50 will transmit the REFER message to the new P-CSCF. The new P-CSCF will record the routing information and IMS session information and forward the same to the LB 20. The new P-CSCF learns of the LB 20 from the REFER message. The LB 20 forwards the REFER message to the UE 10 in the same manner as described above by substituting the source and destination addresses in the outer header in the IP layer header. The UE 10 sends the initial INVITE 600 having the Replace Header. If an S-CSCF 50 fails, the P-CSCF 30 will issue a REFER having a Replace Header. The REFER will be forwarded to the LB 20. The LB 20 will forward the REFER to the UE 10. The UE 10 sends the initial INVITE 600 having the Replace Header as described above.

As will be appreciated by one skilled in the art, the present invention may be embodied as a system, method or computer program product. Accordingly, the present invention may take the fond of an entirely hardware embodiment, an entirely software embodiment (including firmware, resident software, micro-code, etc.) or an embodiment combining software and hardware aspects that may all generally be referred to herein as “modules” or “system.”

Various aspects of the present invention may be embodied as a program, software, or computer instructions embodied in a computer or machine usable or readable storage device, which causes the computer or machine to perform the functionality of the modules and disclosed herein when executed on the computer, processor, and/or machine. A program storage device readable by a machine, tangibly embodying a program of instructions executable by the machine to perform various functionalities and methods described in the present disclosure is also provided.

The system and functionality of the present invention may be implemented and run on a general-purpose computer or special-purpose computer system. The computer system may be any type of known or will be known systems.

The above description provides illustrative examples and it should not be construed that the present invention is limited to these particular example. Thus, various changes and modifications may be effected by one skilled in the art without departing from the spirit or scope of the invention as defined in the appended claims.

What is claimed is:

1. A method for setting up and maintaining an IMS session comprising the steps of:
transmitting an invite message from a registered user equipment, the invite message containing a header and a payload, the header including an identifier for a load balancing node, the load balancing node being assigned to a user equipment;
forwarding the invite message to a selected SIP proxy (P-CSCF) via a load balancing node, the load balancing node modifying the header;
forwarding the invite message to a specified SIP server (S-CSCF); and
relaying the invite message to a destination.

2. The method for setting up and maintaining an IMS session according to claim 1, wherein the step of forwarding the invite message to a selected P-CSCF comprises the sub-steps of:
removing the identifier for the load balancing node from the header;
adding the identifier for the load balancing node into both via and record-route headers; and
determining which P-CSCF of a plurality of P-CSCF is the selected P-CSCF.

3. The method for setting up and maintaining an IMS session according to claim 1, wherein the step of forwarding the invite message to a specified S-CSCF comprises the sub-steps of
determining which S-CSCF of a plurality of S-CSCF is the specified S-CSCF; and
adding routing information into the header of the specified S-CSCF by the load balancing node.

4. The method for setting up and maintaining an IMS session according to claim 1, wherein the step of relaying the invite message to a destination comprises the sub-steps of:
adding the identifier for the load balancing node into both via and record-route headers; and
relaying the invite message through the load balancing node.

5. The method for setting up and maintaining an IMS session according to claim 1, wherein a SIP routing path includes at least two load balancing nodes.

6. The method for setting up and maintaining an IMS session according to claim 5, further comprising the steps of:
exchanging periodically, from each of the at least two load balancing nodes a status message containing the identifier for each of the load balancing nodes.

7. The method for setting up and maintaining an IMS session according to claim 5, further comprising the steps of:
setting one of the two load balancing nodes as a primary load balancing node; and
setting the other of the at least two load balancing nodes as a secondary load balancing nodes.

8. The method for setting up and maintaining an IMS session according to claim 7, further comprising the step of sharing ongoing IMS session information between the primary and the secondary node balancing nodes.

9. The method for setting up and maintaining an IMS session according to claim 8, wherein if the secondary load balancing nodes do not receive s the status message from the primary balancing node within a randomly determined period of time, one of the secondary load balancing nodes becomes the primary load balancing node.

10. The method for setting up and maintaining an IMS session according to claim 9, wherein if one of the secondary load balancing nodes becomes the primary load balancing node, the method further comprises the step of advertising a new status as the primary load balancing node, wherein the identifier for the load balancing node does not change.

11. The method for setting up and maintaining an IMS session according to claim 9, wherein if one of the secondary load balancing nodes becomes the primary load balancing node, the method further comprises the step of notifying each of a plurality of P-CSCF that the original load balancing node is down.

12. The method for setting up and maintaining an IMS session according to claim 9, wherein if one of the secondary load balancing nodes becomes the primary load balancing node, it uses the shared ongoing session information from the primary load balancing node to continue the IMS session, wherein said identifier for the load balancing node does not change.

13. The method for setting up and maintaining an IMS session according to claim 9, wherein if one of the secondary load balancing nodes becomes the primary load balancing node, it obtains the ongoing IMS session information to continue the INS session.

14. The method for setting up and maintaining an IMS session according to claim 1, further comprising the step of registering a user equipment.

15. The method for setting up and maintaining an IMS session according to claim 14, wherein the step of registering the user equipment comprises the sub-steps of:
transmitting a SIP registration request from the user equipment, the SIP registration request including an identifier for the user equipment;
selecting a P-CSCF based upon a selection criterion from a list of a plurality of P-CSCF;
adding the identifier for the load balancing node into both via and record-route headers; and
relaying the SIP registration request to the selected P-CSCF.

16. The method for setting up and maintaining an IMS session according to claim 15, wherein the selection criterion is the identifier for the user equipment.

17. The method for setting up and maintaining an IMS session according to claim 14, further comprising the steps of:
transmitting a SIP ping from the load balancing node to periodically monitor each of the plurality of P-CSCF in the list of a plurality of P-CSCF; and
detecting if a P-CSCF is down based upon a received response to the SIP ping, wherein if the load balancing node does not receive a response to the SIP ping from the selected P-CSCF, the load balancing node selects a new P-CSCF.

18. The method for setting up and maintaining an IMS session according to claim 17, further comprising the steps of:
maintaining a mapping between the registered user equipment and the selected P-CSCF; and
modifying the mapping between the registered user equipment and the selected P-CSCF if the selected P-CSCF is replaced by a new P-CSCF, wherein the identifier for the load balancing node does not change.

19. The method for setting up and maintaining an IMS session according to claim 1, wherein the header includes a SIP layer header and an IP layer header, the IP layer header having an outer header and an inner header, and wherein the step of forwarding the invite message to a selected SIP proxy (P-CSCF) comprises the sub-steps of:
inspecting the outer header for a source of the invite message;
determining the selected P-CSCF based upon the source;
adding routing information for the load balancing node as the source of the invite message in the outer header;
adding routing information for the selected P-CSCF as a destination in the outer header; and
forwarding the invite message via a IPsec tunnel.

20. The method for setting up and maintaining an IMS session according to claim 1, wherein the header includes a SIP layer header and an IP layer header, and wherein the step of forwarding the invite message to a selected SIP proxy (P-CSCF) comprises the sub-steps of:
inspecting the IP layer header for a source of the invite message;
determining the selected P-CSCF based upon the source;
adding routing information for the load balancing node as a source of the invite message; and
adding routing information for the selected P-CSCF as a destination in the outer header.

21. The method for setting up and maintaining an IMS session according to claim 1, wherein the step of forwarding the invite message to a specified SIP server (S-CSCF) comprises the sub-step of:
adding the identifier for the load balancing node into both via and record-route headers in the SIP layer header.
